(19) United States
(12) Patent Application Publication
(10) Pub. No.: US 2004/0157742 A1
(43) Pub. Date: Aug. 12, 2004

(54) Composition containing paraquat and/or diquat an alginate and emetic and/or purgative

(76) Inventors: Emma Jane Ashford, Kent (GB); Jonathan Roy Heylings, Cheshire (GB); Richa Shaunak, Basel (CH)

Correspondence Address: SYNGENTA CROP PROTECTION , INC., PATENT AND TRADEMARK DEPARTMENT, 410 SWING ROAD, GREENSBORO, NC, 27409, US

(21) Appl. No.: 10/472,853

(22) PCT Filed: Mar. 13, 2002
(86) PCT No.: PCT/GB02/01147

(30) Foreign Application Priority Data
Mar. 27, 2001 (GB) 0107651.2

(51) Int. Cl. A01N 43/40; A01N 25/04; A01N 25/16

(52) U.S. Cl. 504/250; 504/366

(57) ABSTRACT

The use of an alginate as a pH-triggered gelling agent in the manufacture of a composition comprising a salt of paraquat, a salt of diquat or a mixture thereof, the composition further comprising an emetic and/or purgative such that a pH-triggered gel effect takes place at the acid pH of human gastric juice. The gelling agent is preferably used in the substantial absence of magnesium trisilicate and preferably has a 1% solution viscosity in water of from 2 to 2000 mPas.

This invention relates to a composition and in particular to an aqueous herbicidal composition, especially an aqueous formulation of a bipyridylium herbicide. The invention also relates to the use of an alginate as a gelling agent in such a formulation.

In EP 0467529 there is described a liquid aqueous herbicidal composition comprising a salt of paraquat or diquat or a mixture thereof, in a concentration of at least 50 grams per litre, in admixture with a suspension of from 10 to 400 grams per litre of a magnesium trisilicate, the composition further comprising an emetic and/or purgative. The magnesium trisilicate forms a gel at the pH of the human gastric juice and the specification further discloses an aqueous liquid herbicidal comprising: (i) a herbicidal component comprising a salt of paraquat or diquat, or a mixture thereof; (ii) a gelling agent that will gel at the pH of human gastric juice; and (iii) an emetic and/or a purgative; wherein the ratio of the herbicidal component to the gelling agent is from 1:1 to 20:1. The object of the invention is to reduce the possibility of harmful effects following the ingestion of a bipyridylium salt. Thus if a quantity of a composition according to the invention is ingested, the acidity of the gastric juice (which varies within quite wide limits but has a mean value of about pH 1.92 for men and pH 2.59 for women) will cause the composition to gel in the stomach. Increasing the viscosity of the gastric contents slows down the rate of gastric emptying. The bipyridylium herbicide will consequently be trapped in the gel, and its movement from the stomach and into the absorptive small intestine will be impede& The emetic present in the composition is absorbed relatively rapidly and will in a short time cause expulsion of the gel containing the bipyridylium herbicide by vomiting, thereby preventing the ingested herbicide from moving further down the gastrointestinal tract, where absorption of the bipyridylium compound would otherwise take place. In preferred compositions a purgative is present in the composition, to assist in removing any non absorbed bipyridylium herbicide which has passed from the stomach into the small intestine despite the action of the emetic. In the event of a bipyridylium composition according to the invention of EP 0467259 being ingested, the combined effects of the gelling agent, emetic, and when included, the purgative, will substantially reduce the absorption of the bipyridylium compound from the gastrointestinal tract into the bloodstream, and thereby to reduce the oral toxicity of the product.

The formulation described in EP 0467259 proved in practice not to be commercially viable. It was found essential to include a thickening or suspending agent to assist in keeping the particles of the insoluble gelling agent, magnesium trisilicate, evenly dispersed throughout the composition during storage and transport. However by its very nature the thickening agent increased the viscosity of the composition and a balance had to be struck between the problems associated with a high-viscosity composition and the need to increase viscosity to minimise settling of the solid inorganic gelling agent. In practice the balance proved an unhappy compromise in that the composition had relatively poor stability as regards settling of the solid gelling agent yet still proved excessively viscous resulting in difficulty in pouring and measuring the composition, difficulty in dispersing the composition effectively in water in the spray tank and difficulty in rinsing empty containers. Settling of the dispersed solid inorganic gelling agent may lead to a concentration gradient of magnesium trisilicate versus emetic such that if only a proportion of a container of formulation is used at any one time, the relative proportions of the ingredients present in the spray tank will not correspond to those intended and the safening effect may in consequence be far from than optimum. The preferred thickening or suspending agent is the xanthan gum sold under the tradename KELZAN and this is the sole suspending agent used in the examples. There is however a brief comment that other suitable suspending agents include alginates.

We have now found that alginates themselves are surprisingly effective pH-sensitive gelling agents for use with bipyridylium salt formulations when used as the pH-sensitive gelling agent.

Thus according the present invention there is provided the use of an alginate as a pH-triggered gelling agent in the manufacture of a composition comprising a salt of paraquat, a salt of diquat or a mixture thereof, the composition further comprising an emetic and/or purgative such that a pH-triggered gel effect takes place at the acid pH of human gastric juice.

It is preferred that the alginate is used as essentially the sole gelling agent.

Thus according to a second aspect of the present invention there is provided an aqueous herbicidal composition comprising a salt of paraquat, a salt of diquat or a mixture thereof, the composition further comprising an emetic and/or purgative wherein a pH-triggered gel effect takes place at the acid pH of human gastric juice characterised in that the gelling agent is an alginate used in the substantial absence of magnesium trisilicate.

Preferably, aqueous compositions according to the invention contain at least 40 grams per litre of paraquat or diquat or mixtures thereof (individually or in combination referred to herein as bipyridylium salt) expressed as bipyridylium ion. The compositions may contain greater than 50 grams per litre, for example greater than 100 grams per litre of bipyridylium ion. Compositions containing 200 grams or more per litre, may be prepared although a concentration of paraquat in excess of about 250 or 300 g/l tends to be unstable. In general compositions do not contain greater than 400 grams per litre of bipyridylium ion.

The term “substantial absence of magnesium trisilicate” as used herein means less than 10 g/l of the composition, more preferably less than 5 g/l of the composition. Whilst the presence of a minor proportion of magnesium trisilicate may not adversely affect the composition of the present invention, there is no particular advantage in including magnesium trisilicate as a gelling agent. In one embodiment of the present invention no magnesium trisilicate is present in the composition. We have found that compositions using alginate as the gelling agent and containing greater than 10 g/l magnesium trisilicate tend to produce a solid deposit on dilution.

It will be appreciated that the object of the use of the alginate in the present invention is radically different to that of a suspending or thickening agent used in EP 0467529. In the present invention, it is desired to provide a relatively low viscosity composition which gels only at the pH of human gastric juice to provide the safening effect. In EP 0467529 the suspending agent is required to keep the solid inorganic gelling agent in suspension by thickening the composition whilst it is at the “normal” pH and before any gel is formed at the acid pH of human gastric juice.

The compositions of the present invention generally exhibit enhanced stability as compared with comparable formulations disclosed in EP 0467529 since in the absence of significant quantities of a solid inorganic gelling agent, there is a greatly reduced need to thicken the composition to ensure stability. It is thus possible to achieve a formulation having excellent physical stability combined with a commercially acceptable low viscosity and good pourability from the container. Furthermore compositions according to the present invention provide a safening effect substantially equivalent to that of compositions described in EP 0467529 in terms of the reduction in systemic exposure to bipyridylium salts in the blood stream. In experiments on non-vomiting species, we have found that a surprisingly increased rate of absorption of emetic relative to paraquat ion is observed for preferred compositions of the invention as compared with compositions such as those described in EP 0467529, and this will provide additional advantages in terms of overall safening of the formulation for vomiting species.

The term alginate as used herein means the class of natural block copolymers extracted from seaweed and consisting of uronic acid units, specifically 1-4a, L-guluronic and 1-4b, D-mannuronic acid, connected by 1:4 glycosidic linkages. The general structure is illustrated in FIG. 1 below.

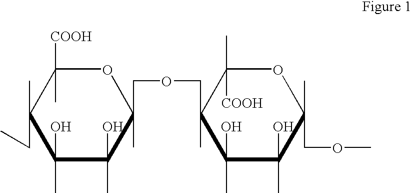

The ratios of mannuronic/guluronic acid residues (M:G) vary depending on the algal source. Typically alginates are classified as being “high-G” or “high-M”. It has generally been found that gel strength increases with the average length of the G blocks and it has been reported that there is a profound effect on gel strength when the average length of the G-blocks is between 5 and 15 (Olav Smidsrd and Kurt Inger Draget, “Food colloids—Proteins, Lipids and Polysaccharides”, p 282). We have found surprisingly that, whilst high G alginates may be used in the composition of the present invention, alginates sold as high M generally provide a superior safening effect. As will be discussed below, this is indicative of the fact that safening does not depend simply on the formation of an effective gel but depends on a number of factors, including for example the relative rates of absorption of the bipyridylium salt and the emetic and the purgative if used. Alginates are often sold in the form of the sodium salt but different commercial grades may contain varying proportions of residual calcium ion. We have found that the calcium content does not greatly affect the stability of the composition but that a low calcium content tends to give an improved safening effect. It is preferred therefore that the calcium content of the alginate (as defined) is less than 2% and preferably less than 1%, for example from 0.1% to 1% and especially from 0.2% to 0.5%.

The average molecular weight of the alginate is preferably from 10,000 to 250,000, for example from 10,000 to 200,000 and more preferably from 10,000 to 150,000. Excellent results are obtained when the molecular weight of the alginate is from 100,000 to 200,000.

The molecular weight of the alginate is reflected in the viscosity of its solution in water under a defined set of conditions. Preferred alginates have an average viscosity in a 1% aqueous solution (referred to herein as the “1% Solution Viscosity”) of from 2 to 2000 mPas, for example from 2 to 1,500 mPas and especially from 2 to 1000 mPas and preferably from 4 to 450 mPas, for example from 20 to 400 mPas at 25° C. as measured using an LV model of the BROOKFIELD viscometer (Brookfield Engineering laboratory, Stoughton, Mass.) at 60 rpm with a number 3 spindle.

Alginates undergo triggered gel formation at the acid pH of the human gastric juice and typical alginates for use in the present invention form a gel at a pH of about pH 3 to 4. The strength of the gel varies depending on the alginate but, as noted above, gel strength is only one of the factors affecting safening in the composition of the invention.

Thus according to a third aspect of the present invention there is provided an aqueous herbicidal composition comprising a salt of paraquat, a salt of diquat or a mixture thereof, the ; composition further comprising an emetic and/or purgative wherein a pH-triggered gel effect takes place at the acid pH of human gastric juice wherein the gelling agent is an alginate having a 1% solution viscosity in water as herein defined of from 2 to 2000 mPas.

A high viscosity of the formulation at its natural (neutral) pH is positively undesirable for most applications and it is preferred that the viscosity of the formulation of the invention (“composition viscosity” as measured using the method of Example 1) is below 200 mPas, for example from 10 to 100 mPas and preferably from 20 to 80 mPas. It will be recognised however that a high viscosity formulation, for example having a viscosity up to 300 mPas or more, may have utility in some specialised applications. The viscosity of the composition will of course depend on the totality of its content including any surfactants present. A typical composition of EP 0467259 having an optimum balance of sufficient suspending agent (KELZAN) to achieve some stability but not being too viscous to be poured or mixed in the spray tank (such as Example 5) has a viscosity of about 160 to 180 mPas.

A further factor to be taken into account in addition to the viscosity measured using the method of Example 1 is the viscosity at very low shear which determines how well the composition pours from a container and how easy it is to rinse out the container when empty. We have found that compositions of the present invention generally pour easily and are more easily rinsed from the container than are those of EP 0467259.

Examples of commercially available alginates suitable for use in the compositions of the present invention are shown in the following Table:

| | Monomer | | 1% Viscosity | Approx. molecular | pH of 1% |
|---|---|---|---|---|---|
| Alginate | ratio | Ca²⁺ content | (mPas) | weight | solution |
| MANUTEX RM | high M:G | low Ca²⁺, 0.4% | 200-400 | 120,000-190,000 | 5.0-7.5 |
| | | max | | | |
| MANUTEX RD | high M:G | low Ca²⁺, 0.4% | 4-15 | 12,000-80,0000 | 5.0-7.5 |
| | | max | | | |
| KELGIN HV | high M:G | high Ca²⁺, | 600-900 | 120,000-190,000 | 6.4-8.5 |
| | | 1.5% max | | | |
| KELGIN LV | high M:G | high Ca²⁺, | 40-80 | 80,000-120,000 | 6.4-8.5 |
| | | 1.5% max | | | |
| MANUGEL | high G:M | low Ca²⁺, 0.2-0.5% | 110-270 | 80,000-120,000 | 5.0-7.5 |
| GMB | | | | | |
| MANUGEL | high G:M | low Ca²⁺, 0.2-0.5% | 50-100 | 80,000-120,000 | 5.0-7.5 |
| GHB | | | | | |
| KELCOSOL | high M:G | high Ca²⁺, | 1000-1500 | 120,000-190,000 | 6.4-8.0 |
| | | 1.5% max | | | |

An especially preferred alginate is that sold under the trade name MANUTEX RM which combines the desirable properties of being high M, low calcium and having a 1% viscosity in the especially preferred range. MANUTEX, MANUGEL, KELGIN and KBLCOSOL are trademarks of ISP Aginates. The concentration of alginate in the composition will generally range from 3 to 50 g/l, for example from 5 to 15 g/l and preferably from 5 to 10 g/l. Higher concentrations may be used if desired but may tend to increase the viscosity of the composition beyond what is acceptable in commercial practice whilst a concentration of below 3 g/l may not provide sufficient safening.

If desired, the pH of the composition may be adjusted to about pH7 (for example between pH 4 and 9 for example between pH 6.5 and 7.5) using conventional pH adjusters such as acetic acid or sodium hydroxide.

If desired other pH-triggered gel-forming polymers may be included in addition to the alginate or a proportion of the alginate may be replaced by such a polymer. Examples of such additional polymers include polyvinylalcohol, partially hydrolysed polyvinylalcohol, polyethylene glycol and pectin.

It is generally desirable to include one or more surfactants or adjuvants in the composition to improve the bioperformance of the herbicide. Such surfactants are well known to those skilled in the art and include cationic, non-ionic and anionic compounds. Examples are listed in EP 0467529 where it is stated however that anionic surfactants are less preferred. We have found that certain surfactants and combinations of surfactants not only improve bioperformance but also may increase the safening effect in the presence of the alginate. The combination of (a) one or more cationic or non-ionic surfactants and (b) one or more anionic surfactants has found to be especially efficacious in terms of either improvement of bioperformance or safening or stability enhancement. The total surfactant concentration is preferably from 25 to 100 g/l of the composition, preferably from 50 to 100 g/l for example from 50 to 70g/l. The ratio of group (a) surfactants to group (b) surfactants is preferably from 1:2 to 10:1 and preferably from 1:1 to 5:1. A typical ratio is 3:2.

Thus according to a fourth aspect of the present invention there is provided an aqueous herbicidal composition comprising a salt of paraquat, a salt of diquat or a mixture thereof, the composition further comprising an emetic and/or purgative wherein a pH-triggered gel effect takes place at the acid pH of human gastric juice wherein the gelling agent is an alginate and wherein the composition comprises (a) one or more cationic or non-ionic surfactants and (b) one or more anionic surfactants.

Whilst preferred compositions of the present invention contain no solid component which has to be suspended and hence do not suffer from the stability problems of compositions of EP 0467529, a slight separation or uneven thickening of the composition may be observed during accelerated storage tests. The preferred surfactant systems of the present invention have been found to be stable over extended test periods.

Examples of suitable anionic surfactants include a salt of an alkyl benzene sulfonate such as sodium or magnesium dodecyl benzene sulfonate (commercially available examples include NANSA HS90/S); alkyl ethoxy carboxylates, for example those of general formula R(OCH₂CH₂)ₙOCH₂CO₂H. where R═C₁₂-C₁₄ alkyl and n=6 to 12 (commercially available examples include EMPICOL CBF and EMPICOL CBL); disodium C₅ to C₂₀ straight or branched chain alkyl sulfosuccinates such as disodium lauryl sulfosuccinate and disodium isodecyl sulfosuccinate (commercially available examples include AEROSOL A268); sodium di(C₅ to C₁₂ straight or branched chain) alkyl sulfosuccinates such as sodium dioctyl sulfosuccinate (commercially available examples include AEROSOL OT); sodium alkyl sulfosuccinates such as sodium lauryl sulfosuccinate (commercially available examples include TEXIN 128 P); sodium naphthalene formaldehyde condensates (commercially available examples include MORWET D425); sodium methyl oleoyl taurate (commercially available examples include ADINOL OT64); ester carboxylates (commercially available examples include EURACOL M, TA); phosphate esters (commercially available examples include CRODAFOS); TEA-PEG-3 cocamide sulfate (commercially available examples include GENAPOL AMS).

Examples of suitable non-ionic surfactants include nonyl phenol ethoxylates (commercially available examples include SYNPERONIC NP8); block copolymers of ethylene oxide and propylene oxide (commercially available examples include SYNPERONIC PE/F88); alkyl amine ethoxylate (commercially available examples include SYNPROLAM 35×15, ETHOMEEN C25 or T25 and NOVAMINE); ethoxylated linear alcohols (commercially available examples include LUBROL 17A17; other alcohol ethoxylates (commercially available examples include SYNPERONIC A range (11, 15, 20, etc), ATPLUS 245); and fatty acid ethoxylates (commercially available examples include CHEMAX). It may be noted that surfactants such as allylamine ethoxylates are sometimes classified as cationic surfactants, but at neutral pH as in most compositions of the present invention they are properly considered to be non-ionic.

Examples of suitable cationic surfactants include amine ethoxylates and alkoxylated. diamines (commercially available examples include JEFFAMINE products).

Preferred combinations of the above include alkyl benzene sulfonates (anionic) and alkyl amine ethoxylates (non-ionic); alkyl amine ethoxylates (non-ionic) and sodum dialkyl sulfosuccinates (anionic); alkyl amine ethoxylates (non-ionic) and disodium alkyl sulfosuccinates; alkyl benzene sulfonates (anionic) and ethoxylated linear alcohols (non-ionic); alkyl benzene sulfonates (anionic) and ethylene oxide propylene oxide block copolymers (non-ionic); alkyl benzene sulfonates (anionic)and alcohol ethoxylates (non-ionic); and alkyl benzene sulfonates (anionic) and sodium dialkyl sulfosuccinates (anionic) and alkyl amine ethoxylates (non-ionic).

The efficacy of the composition in safening bipyridylium salts and in particular the way in which gelation takes place is complex and poorly understood. It is important however that that the bipyridylium salt is “trapped” in the gel such that movement from the stomach and into the absorptive small intestine is impeded since the rate of gastric emptying of viscous material is much slower than for liquid material. In contrast it is desirable that the emetic agent is absorbed as rapidly as possible so as to cause expulsion of the gel containing the bipyridylium salt by vomiting before significant quantities of herbicide can be absorbed into the bloodstream. The purgative agent, magnesium sulphate, is not absorbed and exerts its osmotic purgative action by raising the osmotic pressure of the intestinal contents causing water to flow into the bowel lumen. The safening of the formulation is a synergistic effect of gelling, emesis and purgation. Whilst the scope of the present invention is not to be taken as being limited by any one particular theory it is believed that compositions according to the present invention have a gel structure at low pH which takes the form of globules of gel dispersed throughout a relatively mobile aqueous phase. This may explain the surprising observation that, as compared with compositions of EP 0467529, compositions according to the present invention combine effective reduction in the absorption of the herbicide but do not impair the absorption of the emetic. The emetic agent is much less polar than the bipyridyl ion and therefore will interact with the gel differently. Furthermore, since the emetic agent is more lipophilic than bipyridyls it diffuses at a faster rate from the stomach contents into the mucosa and it is believed that this process is not impeded by the components of the formulation.

However, regardless of any particular theory, tests on a non-vomiting species (rabbit) indicate that a surprisingly increased rate of absorption of emetic relative to paraquat ion is observed for preferred compositions of the invention as compared with compositions such as those described in EP 0467529.

Paraquat is the common name of the 1,1′-dimethyl-4,4′-bipyridylium cation. Diquat is the common name of the 1,1′-ethylene-2,2′-bipyridylium cation. Salts of paraquat and diquat necessarily contain anions carrying sufficient negative charges to balance the two positive charges on the bipyridylium nucleus.

Since the characteristic herbicidal effect of a bipyridylium quaternary cation is independent of the nature of the associated anion, the choice of the anion is a matter of convenience, depending, for example, on cost. Preferably the anion is one which gives rise to a salt of convenient water solubility. Examples of anions, which may be mono- or polyvalent, include acetate, benzenesulfonate, benzoate, bromide, butyrate, chloride, citrate, fluorosilicate, fumarate, fluoroborate, iodide, lactate, malate, maleate, methylsulphate, nitrate, propionate, phosphate, alicylate, succinate, sulphate, thiocyanate, tartrate, and p-toluenesulfonate. The salt of the herbicidal bipyridylium saltiom cation may be formed from a number of similar anions or mixtures of different ones. For reasons of convenience and economy, paraquat is normally manufactured an sold as paraquat dichloride while diquat is manufactured and sold as diquat dibromide.

Since the characteristic herbicidal activity of a salt of a herbicidal bipyridylium quaternary cation resides in the cation only, it is customary to quote concentrations of active ingredient and rates of application in terms of the amount of bipyridylium quaternary cation unless otherwise stated.

If desired the paraquat or diquat may be used in the formulation of the present invention in combination with another agrochemical active ingredient and in particular with another herbicide. Typical mixture partners for paraquat and diquat useful for incorporation in compositions of the present invention include ametryn, diuron, atrazine, glyphosate, butafenacil, metribuzin, prometryn, and terbutylazine. Many other possible mixture partners which may either be incorporated in a composition of the present invention or used in a tank mix with a composition of the present invention will occur to those skilled in the art. Representative examples include 2,4-D, AC304415; Acetochlor, Aclonifen, Alachlor, Amicarbazone, Aminotriazole, Azafenidin, BAS145138, Benoxacor, Bentazon, Bialophos, Bromoxynil, Butylate, Carfentrazone-ethyl, CGA 276854, Clomazone, Clopyralid, Cloquintocet-metxyl, Cloransulam, Cyanazine, Dicamba, Dichlormid, Diclosulam, Diflufenzopyr, Dimethanamid, Fenclorim, Fentrazimide, Florasulam, Flufenacet, Flumetsulam, Flumiclorac-pentyl, Flumioxazin, Flurazole, Fluroxypyr, Fluthiacet-methyl, Fluxofenim, Foramsulfuron, Furilazole, Glufosinate, Halosulfuron-methyl, Halosulfuron-methyl, Imazamox, Imazapyr, Imazaquin, Imazethapyr, Iodosulfuron, Isopropazol, Isoxachlortole, Isoxaflutole, MCPA, MCPB, MCPP, Mefenpyr, Mesotrione, Metobenzuron,. Metolachlor, Metosulam, MON4660, Nicosulfuron, NOA-402989, Pendimethalin, Primisulfuron, Profluazol, Prosulfuron, Pyridate, Rimsulfuron, S-Dimethanamid, Sethoxydim, S-glufosinate, Simazine, Slurtamone, S-Metolachlor, Sulcotrione, Sulfentrazone, Sulfosate, Terbutryn, Thifensulfuron and Tritosulfuron.

A variety of known emetics may be used in the compositions of the invention. However, preferred emetics are those compounds disclosed in UK Patent No. 1507407 for use in formulations of bipyridylium herbicides, and a particularly preferred emetic is 2-amino-6-methyl-5-oxo4-n-propyl-4,5-dihydro-5-triazolo[1,5-a]-pyrimidine.

The amount of emetic used in the composition will vary depending upon the particular type of emetic used, but when an emetic of the class disclosed in UK Patent No. 1507407 is used, the concentration of emetic is preferably from 0.1 to 5 grams per litre of the composition. For a composition containing 200 grams per litre of bipyridylium compound, a concentration of 1.5 to 2.0 grams per litre of emetic is preferred.

When the composition of the invention contains a purgative, this is preferably magnesium sulphate. The concentration of magnesium sulphate is preferably from 10 to 400 grams per litre of the composition, and more preferably from 10 to 100 grams per litre. Higher concentrations of magnesium sulphate, for example up to 400 grams per litre, may be used and may continue to provide increased purgative effect but such high levels of magnesium sulphate may have an adverse effect on formulation stability.

The composition of the invention may also contain conventional additive such as an odourant (alerting agent), for example as a pyridine derivative, as described in UK Patent No. 1406881, or n-valeric acid. The compositions may also comprise a pigment or a dye to give them a distinctive colour.

Compositions of the present invention may be prepared simply and conveniently by mixing the components. It is generally preferred to add solid alginate to an aqueous solution of the bipyridylium salt, since a more homogeneous composition is obtained than when alginate is first mixed into water and an aqueous solution of bipyridylium salt is subsequently added. For example the bipyridylium salt is mixed into water optionally in the presence of the emetic and the alginate is then added with mixing. Purgative is added followed by the anti-foam, surfactant system, dye and odourant. Finally and if desired the pH is adjusted to neutral.

Thus a typical order of addition of the components would be:

a) prepare an aqueous concentrate of the bipyridylium salt containing the desired proportion of emetic (typically containing for example 30% to 40% by weight of paraquat ion in water);

(b) if necessary add a further quantity of water to bring the total quantity of water to just short of the desired quantity (to allow for final adjustment); (c) add the alginate; (d) add the purgative, antifoam, surfactants, dye and odourant (if used); (e) adjust the pH if necessary and (f) if necessary add a final quantity of water to adjust all concentrations to the desired values. The composition is preferably stirred throughout each stage.

It will be appreciated that the amount of water to be added in step (b) above will depend on the initial concentration of the aqueous concentrate commercially available as feedstock in step (a).

Thus according to a further aspect of the present invention there is provided a method of preparing an aqueous herbicidal composition comprising a salt of paraquat, a salt of diquat or a mixture thereof which comprises the steps of forming an aqueous solution comprising a salt of paraquat, a salt of diquat or a mixture thereof and subsequently adding a solid alginate to said solution.

The invention is illustrated by the following Examples in which all parts and percentages are by weight unless otherwise stated. The concentration of adjuvants is in each case given in terms of the weight of composition used. The concentration of adjuvant in the composition is given when it is less than 100%. For example the product NANSA HS90/S is supplied as a 90% by weight solution of sodium dodecyl benzene sulfonate.

### EXAMPLE 1

A composition according to the present invention was prepared having the following composition:

| COMPONENT | CONCENTRATION | |
|---|---|---|
| Paraquat dichloride | 200 | g/l (paraquat ion) |
| SYNPROLAM 35 × 15 | 31 | g/l |
| Magnesium dodecyl benzene sulfonate | 19 | g/l |
| MANUTEX RM | 5 | g/l |
| Magnesium sulphate | 74 | g/l |
| Acetic Acid | To pH 6.5-7.5 | |
| Emetic | 0.5 | g/l |
| 2-amino-6-methyl-5-oxo-4-n-propyl-4,5- | | |
| dihydro-5-triazolo[1,5-a]-pyrimidine | | |
| Water | To 1 | liter |

SYNPROLAM 35×15 is an alkyl amine ethoxylate with a molecular formula that can be written as R—N(CH₂CH₂O)ₓH(CH₂CH₂0)_{y}H where the sum of x and y is 15 and R═C₁₃-C₁₅. MANUTEX RM is a high M alginate having a low calcium content (0.4% maximum) and a 1% solution viscosity of 200 to 400 mPas.

The composition has a viscosity as measured using using a Paar Physica Haake MC1+ High Shear Rheometer at 25° C. at 300 s⁻¹ (“composition viscosity”) of 44.0 mPas. The stability of the composition is given in Example 7.

### EXAMPLE 2

A composition according to the present invention was prepared having the following composition:

| COMPONENT | CONCENTRATION | |
|---|---|---|
| Paraquat dichloride | 200 | g/l (paraquat ion) |
| SYNPROLAM 35 × 15 | 31 | g/l |
| AEROSOL OT-B | 19 | g/l |
| MANUTEX RM | 10 | g/l |
| Magnesium sulphate | 74 | g/l |
| Acetic Acid | To pH 6.5-7.5 | |
| Emetic as Example 1 | 0.5 | g/l |
| Water | To 1 | liter |

AEROSOL OT-B contains 85% sodium dioctyl.sulfosuccinate and 15% sodium benzoate. The composition had a composition viscosity of 68.0 mPas. The stability of the composition is given in Example 7.

### EXAMPLE 3

A composition according to the present invention was prepared having the following composition:

| COMPONENT | CONCENTRATION | |
|---|---|---|
| Paraquat dichloride | 200 | g/l (paraquat ion) |
| SYNPROLAM 35 × 15 | 31 | g/l |
| AEROSOL A-268 | 19 | g/l |
| MANUTEX RM | 10 | g/l |
| Magnesium sulphate | 74 | g/l |
| Acetic Acid | To pH 6.5-7.5 | |
| Emetic as Example 1 | 0.5 | g/l |
| Water | To 1 | liter |

AEROSOL A-268 is disodium isodecyl sulfosuccinate.

The composition had a composition viscosity of 19.0 mPas. The stability of the composition is given in Example 7.

### EXAMPLE 4

A composition according to the present invention was prepared having the following composition:

| COMPONENT | CONCENTRATION | |
|---|---|---|
| Paraquat dichloride | 200 | g/l (paraquat ion) |
| SYNPROLAM 35 × 15 | 43 | g/l |
| NANSA HS90/S | 27 | g/l |
| MANUTEX RD | 25 | g/l |
| Magnesium sulphate | 74 | g/l |
| Acetic Acid | To pH 6.5-7.5 | |
| Emetic as Example 1 | 0.5 | g/l |
| Water | To 1 | liter |

NANSA HS90/S is sodium dodecyl benzene sulfonate.

MANUTEX RD is a high M alginate having a low calcium content (0.4% maximum) and a 1% solution viscosity of 4-15 mPas.

The composition had a composition viscosity of 91.1 mPas. The stability of the composition is given in Example 7.

### EXAMPLE 5

A composition according to the present invention was prepared having the following composition:

| COMPONENT | CONCENTRATION | |
|---|---|---|
| Paraquat dichloride | 200 | g/l (paraquat ion) |
| SYNPROLAM 35 × 15 | 43 | g/l |
| NANSA HS90/S | 27 | g/l |
| MANUGEL GMB | 50 | g/l |
| Magnesium sulphate | 74 | g/l |
| Acetic Acid | To pH 6.5-7.5 | |
| Emetic as Example 1 | 0.5 | g/l |
| Water | To 1 | liter |

MANUGEL GMB is a high G alginate having a low calcium content (0.2 to 0.5%) and a 1% solution viscosity of 100-270 mPas.

The composition had a composition viscosity of 418.0 mPas.

### EXAMPLE 6

A composition according to the present invention was prepared having the following composition:

| COMPONENT | CONCENTRATION | |
|---|---|---|
| Paraquat dichloride | 200 | g/l (paraquat ion) |
| SYNPROLAM 35 × 15 | 43 | g/l |
| NANSA HS90/S | 27 | g/l |
| MANUTEX RM | 17 | g/l |
| Magnesium sulphate | 74 | g/l |
| Acetic Acid | To pH 6.5-7.5 | |
| Emetic as Example 1 | 0.5 | g/l |
| Water | To 1 | liter |

The composition had a composition viscosity of 281.5 mPas.

### EXAMPLE 7

A comparison sample was prepared corresponding essentially to that of Example 5 of EP 0467529:

| COMPONENT | CONCENTRATION | |
|---|---|---|
| Paraquat dichloride | 200 | g/l (paraquat ion) |
| SYNPERONIC NP8 | 35 | g/l |
| NANSA 1169PS | 117 | g/l |
| KELZAN | 3 | g/l |
| Magnesium sulphate | 50 | g/l |
| Magnesium trisilicate | 100 | g/l |
| Compound A (Emetic of Example 1) | 1.65 | g/l |
| Pyridine base | 10.0 | g/l |
| Sulfacide Blue 5J liquid | 5.0 | g/l |
| Silcolapse 5020 (antifoam) | 0.25 | |
| Acetic Acid | To pH 6.5-7.5 | |
| Water | To 1 | liter |

The stability of the compositions of Examples 1 to 4 was compared with that of the comparison. Samples were stored for from 4 to 8 weeks at a constant temperature (25° C., 40° C. or 50° C. as indicated). Any slight separation was noted. Substantial separation was measured as the height of the separated phase divided by the height of the total composition multiplied by 100 (%).

| | Temperature | Length of | | Separation |
|---|---|---|---|---|
| Example | of Storage | Storage | Description of Separation | (%) |
| Comparison | 50° C. | 4 weeks | Unacceptable Separation. | 30% |
| 1 | 40° C. | 8 weeks | No separation observed on removal | 0 |
| | | | from oven. After equilibrating at | |
| | | | room temperature for 24 hours, a | |
| | | | slight grainy residue was observed. | |
| 2 | 50° C. | 8 weeks | No separation observed either on | 0 |
| | | | removal from oven or on | |
| | | | equilibrating at room temperature. | |
| 3 | 50° C. | 8 weeks | No separation observed either on | 0 |
| | | | removal from oven or on | |
| | | | equilibrating at room temperature. | |
| 4 | 50° C. | 4 weeks | No separation observed either on | 0 |
| | | | removal from oven or on | |
| | | | equilibrating at room temperature. | |

### EXAMPLE 8

The compositions of Examples 1 to 6 exhibited a safening effect (as determined in rabbit by a reduction in the systemic exposure to bipyridylium salt at constant dosage) which was largely equivalent to that of the composition of Example 5 of EP 0467529 and which was significantly better than a corresponding composition containing no magnesium trisilicate or alginate gelling agent.

### EXAMPLE 9

A composition according to the present invention was prepared having the following composition:

| COMPONENT | CONCENTRATION | |
|---|---|---|
| Paraquat dichloride | 120 | g/l (paraquat ion) |
| Diquat | 80 | g/l |
| AEROSOL OT-B | 22 | g/l |
| ETHOMEEN T 25 | 31 | g/l |
| MANUTEX RM | 10 | g/l |
| Magnesium sulphate | 21 | g/l |
| Antifoam | 0.5 | g/l |
| Sulfacid blue 5J | 2.5 | g/l |
| Alerting Agent | 0.10 | |
| Acetic Acid | To pH 6.5-7.5 | |
| Emetic as Example 1 | 0.5 | g/l |
| Water | To 1 | liter |

The composition had a composition viscosity of 154.7 mPas.

### EXAMPLE 10

A composition according to the present invention was prepared having the following composition:

| COMPONENT | CONCENTRATION | |
|---|---|---|
| Paraquat dichloride | 200 | g/l (paraquat ion) |
| AEROSOL OT-B | 22 | g/l |
| SYNPROLAM 35 × 15 | 31 | g/l |
| MANUTEX RM | 10 | g/l |
| Pectin | 5.0 | g/l |
| Magnesium sulphate | 74 | g/l |
| Anitfoam | 0.25 | g/l |
| Sulfacid blue 5J | 2.5 | g/l |
| Alerting Agent | 0.10 | |
| Acetic Acid | To pH 6.5-7.5 | |
| Emetic as Example 1 | 1.5 | g/l |
| Water | To 1 | liter |

The composition had a composition viscosity of 123.0 mPas. The Composition was stable after storage for 2 weeks at −10° C. and at 54° C. respectively.

### EXAMPLE 11

A composition according to the present invention was prepared having the following composition:

| COMPONENT | CONCENTRATION |
|---|---|
| Paraquat dichloride | 200 g/l (paraquat ion) |
| NANSA 1169A | 63.3 g/l |
| Ethomeen T25 | 31 g/l |
| MANUTEX RM | 10 g/l |
| Magnesium sulphate | 74 g/l |
| Anitfoam | 0.25 g/l |
| Sulfacid blue 5J | 2.5 g/l |
| Alerting Agent | 0.10 |
| Acetic Acid | To pH 6.5-7.5 |
| Emetic as Example 1 | 1.5 g/l |
| Water | To 1 liter |

The composition had a composition viscosity of 91.99 mPas. The Composition was stable after storage for 2 weeks at −10° C. and at 54° C. respectively.

### EXAMPLE 12

A composition according to the present invention was prepared having the following composition:

| COMPONENT | CONCENTRATION |
|---|---|
| Paraquat dichloride | 200 g/l (paraquat ion) |
| AEROSOL OT-B | 22 g/l |
| SYNPROLAM 35 × 15 | 31 g/l |
| MANUTEX RM | 10 g/l |
| Magnesium sulphate | 74 g/l |
| Anitfoam | 0.25 g/l |
| Sulfacid blue 5J | 2.5 g/l |
| Alerting Agent | 0.10 |
| Acetic Acid | To pH 6.5-7.5 |
| Emetic as Example 1 | 1.5 g/l |
| Water | To 1 liter |

The composition had a composition viscosity of 84.07 mPas. The Composition was stable after storage for 2 weeks at −10° C. and at 54° C. respectively.

### EXAMPLE 13

A composition according to the present invention was prepared having the following composition:

| COMPONENT | CONCENTRATION |
|---|---|
| Paraquat dichloride | 200 g/l (paraquat ion) |
| AEROSOL OT-B | 22 g/l |
| Ethomeen T25 | 31 g/l |
| MANUTEX RM | 10 g/l |
| Magnesium sulphate | 74 g/l |
| Anitfoam | 0.25 g/l |
| Sulfacid blue 5J | 2.5 g/l |
| Alerting Agent | 0.10 |
| Acetic Acid | To pH 6.5-7.5 |
| Emetic as Example 1 | 1.5 g/l |
| Water | To 1 liter |

The composition had a composition viscosity of 74.58 mPas. The Composition was stable after storage for 2 weeks at −10° C. and at 54° C. respectively.

### EXAMPLE 14

The pourabilities of compositions of the present invention were compared to that of a composition of EP 0467259. The CIPAC MT 148 method was followed which involved filling a 500 mL measuring cylinder of known weight to the 400 mL mark. This was then weighed and allowed to stand undisturbed for 24 h. After this time, the contents were poured out for 60 s at an angle of 45 ° and then fully inverted for a further 60 s. The measuring cylinder was then reweighed (the % residue can then be calculated), rinsed with 400 mL distilled water, inverted 10 times and then emptied as before. The final weight was then recorded and the rinsed residue calculated. The results of four formulations are shown below:

| | | Rinsed |
|---|---|---|
| Composition | Residue (% w/w) | Residue (% w/w) |
| Example 11 | 2.07 | 0.19 |
| Example 12 | 2.13 | 0.27 |
| Example 13 | 2.02 | 0.16 |
| Comparison from Example 7 | 3.99 | 0.35 |
| (Example 5 of EP 0467529.) | | |

1 The use of an alginate as a pH-triggered gelling agent in the manufacture of an aqueous composition comprising an aqueous solution of a salt of paraquat, a salt of diquat or a mixture thereof, the composition further comprising an emetic and/or purgative such that a pH-triggered gel effect takes place at the acid pH of human gastric juice and wherein the composition is prepared by mixing the components.

2. An aqueous herbicidal composition embodying the use of an alginate according to claim 1 comprising a salt of paraquat, a salt of diquat or a mixture thereof, the composition further comprising an emetic and/or purgative wherein a pH-triggered gel effect takes place at the acid pH of human gastric juice, characterised in that the gelling agent is an alginate used in the substantial absence of magnesium trisilicate.

3. An aqueous herbicidal composition according to claim 2 containing less than 10 grams per litre of magnesium trisilicate.

4. An aqueous herbicidal composition embodying the use of an alginate according to claim 1 comprising a salt of paraquat, a salt of diquat or a mixture thereof, the composition further comprising an emetic and/or purgative wherein a pH-triggered gel effect takes place at the acid pH of human gastric juice and wherein the gelling agent is an alginate having a 1% solution viscosity in water as herein defined of from 2 to 2000 mPas.

5. An aqueous composition according to claim 4 wherein the alginate has 1% solution viscosity in water as herein defined of from 2 to 1000 mPas.

6. An aqueous composition according to claim 5 wherein the alginate has 1% solution viscosity in water as herein defined of from 20 to 400 mPas.

7. An aqueous composition according to any of claims 2 to 6 wherein the alginate is classified as High M.

8. An aqueous composition according to any of claims 2 to 7 wherein the calcium content of the alginate is less than 1%.

9. An aqueous composition according to any of claims 2 to 8 wherein the concentration of the alginate in the composition is from 3 to 50 g/l.

10. An aqueous composition according to any of claims 2 to 9 wherein the pH is adjusted to between pH 4 to pH 9.

11. An aqueous composition according to any of claims 2 to 10 comprising an additional pH-triggered gel-forming polymer selected from polyvinylalcohol, partially hydrolysed polyvinylalcohol, polyethylene glycol and pectin.

12. An aqueous composition according to any of claims 2 to 11 wherein the composition additionally comprises (a) one or more cationic or non-ionic surfactants and (b) one or more anionic surfactants.

13. An aqueous composition according to claim 12 wherein the anionic surfactant is selected from a salt of an alkyl benzene sulfonate, alkyl ethoxy carboxylates, disodium C₅ to C₂₀ straight or branched chain alkyl sulfosuccinates, sodium di(C₅ to C₁₂ straight or branched chain) alkyl sulfosuccinates, sodium alkyl sulfosuccinates, sodium naphthalene formaldehyde condensates, sodium methyl oleoyl taurate, ester carboxylates, phosphate esters and cocamide sulfate.

14. An aqueous composition according to claim 12 wherein the non-ionic surfactant is selected from nonyl phenol ethoxylates, block copolymers of ethylene oxide and propylene oxide, alkyl amine ethoxylates, ethoxylated alcohols and fatty acid ethoxylates.

15. An aqueous composition according to claim 12 wherein the cationic surfactant is selected from amine ethoxylates and alkoxylated diamines.

16. An aqueous composition according to any of claims 12 to 15 wherein the total surfactant concentration is from 25 to 100 g/l of the composition.

17. An aqueous composition according to any of claims 2 to 17 wherein the emetic is 2-amino-6-methyl-5-oxo4-n-propyl-4,5-dihydro-5-triazolo[1,5-a]-pyrimidine.

18. An aqueous composition according to any of claims 2 to 18 wherein the purgative, if used, is magnesium sulphate.

19. An aqueous composition according to any of claims 2 to 19 which contains greater than 50 grams per litre of bipyridylium ion.

20. A method of preparing a composition according to any of the preceding claims which comprises the steps of forming an aqueous solution comprising a salt of paraquat, a salt of diquat or a mixture thereof and subsequently adding a solid alginate to said solution.

21. A process for killing or controlling unwanted plant species which process comprises applying to the plant or to the locus thereof, an effective amount of an aqueous composition according to any of claims 2 to 19.
